(19) United States
(12) Patent Application Publication
(10) Pub. No.: US 2004/0222770 A1
(43) Pub. Date: Nov. 11, 2004

(54) Battery quality monitoring method

(76) Inventor: Einar Gottas, Oslo (NO)

Correspondence Address: LADAS & PARRY LLP, 224 SOUTH MICHIGAN AVENUE, SUITE 1200, CHICAGO, IL, 60604, US

(21) Appl. No.: 10/297,075

(22) PCT Filed: May 29, 2001
(86) PCT No.: PCT/NO01/00222

(30) Foreign Application Priority Data
May 29, 2000 (NO) 20002751

(51) Int. Cl. H02J 7/00

(52) U.S. Cl. 320/134; 320/136; 340/636.1

(57) ABSTRACT

Battery quality is monitored by means of a monitoring system that presents current physical parameters of single cells as deviations from the average parameter value of all cells. Battery performance is calculated from the time progress of a number of the largest deviations for single cells.

The present invention relates to a method for estimating the quality of an accumulator battery, a so-called secondary battery. There exists today a large plurality of methods which are all based on one or some few single measurements of parameters of the complete battery, for example the total battery voltage. The present invention is based upon analyzing a very large number of measurement values collected from every single battery cell.

The traditional operation of chargeable batteries, accumulators, is based on the assumption that all single cells of the battery are identical and respond in a similar manner to every excitation and load. This assumption should be fulfilled in order that recharging and discharging of the battery with a current that is necessarily the same, shall result in an equal load for every single cell.

However, the assumption that the cells are identical, is not correct. All experience indicates so. Experience also shows that a battery is never better than the poorest cell. If one cell fails, the complete battery fails. It turns out that the batteries exhibit both predictable and apparently random characteristics. The present invention will deal with both of these possibilities.

At present there are measurement systems that in a useful and cost effective manner enable measurement of several parameters from each respective cell in a battery. For instance cell voltage, cell temperature and voltage drop across the connection between respective cells are measured. For batteries with a liquid electrolyte, the acid level can be measured also.

For many batteries, the lifetime will be highly dependent on temperature. For example, the lifetime of a lead accumulator is reduced by 50% for every 8 degree temperature rise above 20° C. This phenomenon is the result of chemical reaction rates in the batteries.

As previously mentioned, a battery is a long chain of single cells. The complete battery will never have a longer lifetime or available discharge capacity, than the lifetime or discharge capacity of the poorest cell.

There exists today a number of theories and methods for studying battery quality. Regrettably, all these theories presume that all cells are identical and respond equally to all influences. As mentioned, this turns out to be incorrect.

The previously known methods deal with measurement of some primary parameters like voltage, temperature and acid level. Secondary parameters or derived parameters are measured also. One may mention for example internal resistance, “voltage sack”, symmetry measurements between 4 part blocks of the battery, etc.

British patent publication GB 1.494.458 describes testing of batteries at the end of a production line. The test is made by sending a current pulse with a duration of a few seconds through the battery, and voltage transients are recorded for each single cell and for the complete battery, either as a continuous value through the whole duration of the current pulse, or at the start of the current pulse and approximately half way in the current pulse. The value(s) for each single cell is/are compared to the average for the complete battery, and if possible deviations for one or more cells exceed a value that has been pre-set, the battery is evaluated as not having the necessary quality. Hence, this test is a one-time test.

A method for controlling the quality of a multicell battery is previously known from German patent publication DE 195 23 260. In this patent, a calculation is made of average values for all cells, and a warning signal is given if a cell parameter deviates to a larger degree than what has been determined in advance, from the average value. In this case, the strategy is simply to take a look at the magnitude of the deviation.

However, the methods appearing from the publications mentioned above, are a little too crude in their approach. It is not necessarily so that a single cell is in a state in which corrective measures are needed, even if the cell in an instantaneous test will exhibit a deviating value that does not look good. Single cells may have oscillating parameter values, and it is therefore necessary to refine the prior art method further.

The object of the present invention is to achieve an improved monitoring routine that provides the possibility for more correct evaluation of the condition of single cells and the need of corrective measures. The object of the invention is obtained by a method such as described in the appended claim 1. Special and favorable embodiments of the method of the invention will appear from the consecutive claims 2-9.

The methodology of the invention will be applicable in all analysis philosophies known today, and they will be improved substantially.

In the following, the invention shall be discussed in more detail, in particular with regard to battery statistics, battery operation and a statistic model for the invention.

Statistics of a Battery:

From experience, common knowledge is that in a modern battery, approximately 1-2% of the single cells will have a quite significantly poorer quality than the remaining cells. In a large battery having for example as many as 200 single cells, this means that 2-4 single cells will put a limit to the quality of the battery.

Battery Operation:

If “poor” cells are detected early, there are actually several possibilities for “saving” the battery. If the poor cells are detected at an early stage of the battery lifetime, i.e. during the first 24 months, single cells can be replaced by new ones. If the battery is older, cells cannot be replaced, because a new cell will no longer be identical to and respond similarly as the original cells.

However, there exists a methodology for “equalizing” differences between single cells in a battery, if these differences are detected.

In a lead battery in which the dispersion in cell voltages has become large, this can for example be rectified by means of relatively short and very strong excess recharging.

Using a battery monitoring system that is able to communicate with measurement sensors on each respective cell, it is possible to control the maintenance recharging current individually in every single cell, via a small current shunt on each cell.

The present invention describes a methodology for calculating the basis for this kind of battery handling.

The Statistical Model of the Invention:

A battery having 24 to 200 single cells will represent a very good statistical selection of typical battery cells, with the age in question and alterations from original specifications and characteristics, governed by natural laws.

With a battery monitoring system which makes measurements of single cell parameters, it will be possible to use the average values of primary parameters as well as secondary parameters as the measure of a “standard cell” in the further analysis. This standard cell will then exhibit characteristics and time progress lying very closely to what the supplier has stated.

With the same monitoring system it will be possible to integrate the positive temperature deviation from 20° C. for each cell. Based upon the fact that the lifetime is halved for every 8 degrees positive deviation, a very good estimate of maximum possible lifetime for the hottest cell can be prepared. Again, when one cell is defective, the whole battery will fail.

In a calculation, all primary and secondary cell parameters, as well as the temperature integral, may be presented as deviations from the average value. The average value itself will also be interesting.

With the same monitoring system it will also be possible to compute progress in time for these single cell deviations, and hence enable an extra-polation toward a possible time for breakdown, if the deviations are rising or falling monotonously from the average value.

Since experience shows that single cells that stay “healthy” will exhibit a somewhat “oscillating” progress over time for parameters of interest, it is important that the monitoring routine is able to detect cells having monotonously increasing or decreasing deviation values, because such progress over a long time indicates that the cell has a weakness. Consequently, it will be possible to subject cells of this type to special recharging programs to provide correctional effect, a long time before the cells reach a destroyed condition with irrepairable parameter values.

Hence, the present invention has as its inherent principle, that battery quality is connected to the time progress of a number of the largest deviations or single cells. It is for instance possible to determine that, for a certain parameter, for example internal resistance, one shall take a look at the four single cells having the largest deviation from the average value for all single cells. If the time progress is oscillating for these four single cells, i.e. that some of them will not even have large deviations further ahead in time, the battery quality will be evaluated as good, in accordance with calculation criteria established in advance.

On the other hand, if it should turn out that the time development for this example with four single cells is of a monotonous type, and runs along toward increasing values, a quality result will be provided that is not so good. At the same time, one will then have a full overview picture of these special single cells with monotonously (or decreasing) deviation values, and corrective measures may be started.

Battery quality can be stated as a function of dispersion, or standard deviation, for the measured single cell parameter values.

With the monitoring method indicated here, it will also be natural to utilize extrapolation in order to estimate battery quality in the future.

As regards corrective measures, it will be possible to connect a current shunt periodically on cells that turn out to have a high voltage during maintenance recharging, and by means of such a measure, the recharging current can be increased, so that cells having a low voltage during such maintenance recharging, will receive a stronger recharging current than the cells having such a current shunt.

It is of course possible to combine monitoring system and recharging unit, for instance by controlling a battery charger so that it executes automatic and extended test routines. Such an advanced battery charger will then be equipped with special recharging programs for counteracting established deviation values for which single cells are about to exhibit monotonous development.

1. A method for monitoring and determining quality of a battery consisting of several single cells in series, all cells, or a quite significant number of the cells, being monitored with regard to variations in one or more physical battery parameters, using a monitoring system, said monitoring system presenting all parameters as deviations from average values for all cells,
characterized in that the monitoring system calculates battery performance from progress in time of a number of the largest deviations for single cells.

2. The method of claim 1,
characterized in that said monitoring system presents both primary parameters and possibly measured secondary parameters as such a deviation from the cell average.

3 The method of claim 1,
characterized in that an integral of all deviations over time is calculated, and that said integral is used as a measure of performance for each single cell and hence for the complete battery.

4. The method of claim 1,
characterized in that a time integral is calculated for the temperature deviation above 20° C. in each respective cell, and that maximum lifetime for the battery is computed from the largest deviation integrals.

5. The method of claim 1,
characterized in that the general quality of the battery is stated by means of dispersion or standard deviation in the measured single cell values.

6. The method of claim 1,
characterized in that change over time in the deviation for each single cell, relative to the battery average for every parameter, is used as a measure of quality, and that the same measurements are used, by extrapolation, for estimating the battery quality in the future.

7. The method of claim 1,
characterized in that a battery charger is controlled for executing automatic extended test routines and special recharging programs for counter-acting deviating characteristics about to be developed in single cells.

8. The method of claim 1,
characterized in that a current shunt is connected periodically across cells exhibiting a high voltage during maintenance charging, and that the charging current is increased, so that cells originally exhibiting a low voltage, receive a higher charging current.

9. The method of claim 1,
characterized in that the monitoring system presents parameters from a group that includes terminal voltage, temperature, acid level, internal resistance, “voltage sack” and symmetry between cells in a small group of cells.
